(19) United States
(12) Patent Application Publication
(10) Pub. No.: US 2007/0054017 A1
(43) Pub. Date: Mar. 8, 2007

(54) Warm particle suspension and injection process for meat

(76) Inventor: David Alan Palmer, Green Bay, WI (US)

Correspondence Address: David Palmer, 2911 Bay Settlement Road, Green Bay, WI, 54311, US

(21) Appl. No.: 11/162,268

(22) Filed: Sep. 4, 2005

(51) Int. Cl. A23L 1/31

(52) U.S. Cl. 426/281

(57) ABSTRACT

A process for injecting a warm particle suspension consisting of fatty trim from like meat, without the need for brine, into relatively colder, raw meat muscle thereby increasing the weight and improving the flavor of said untreated meat.

### BACKGROUND OF THE INVENTION

The present invention is directed to a meat injection process for increasing the green weight of the meat and improving the flavor of the meat by means of marbling the lean meat. Numerous industry studies have found that consumers prefer the flavor of more marbled meat. Many techniques to improve marbling have been developed over time from genetic selection, to larding, to grading, to hot fat injection, and to cold suspension injection. They each have weaknesses that cause consumer dissatisfaction from eating quality inconsistency, to high cost, to use of non-meat additives. Various processes of this general type are described in the prior art U.S. Pat. Nos. 3,215,534, 3,835,223, 3,989,851, 4,402,987, RE 30,023, 4,960,599, and 5,039,538. None of these processes disclose the steps of the present process.

### SUMMARY OF THE INVENTION

The present invention provides a process for injecting a warm trim suspension into a colder meat mass. The process does not require a brine solution or any other non-meat additive to create a suspension that can be injected. Unlike processes that inject a hot fat solution, this process can inject whole meat trimmings without denaturing the lean meat or requiring other non-meat additives.

The process includes first removing the trim from the meat. The trim consists of fat and lean. The trim is then cooled and ground by a grinding apparatus and maintained at a temperature under 40 degrees Fahrenheit until ready to process further. The ground fatty trim is next heated to liquefy the fat. The solution is passed through a mill to reduce the lean particles to a size that will pass through the holes of the injector. This milled solution forms a suspension. The temperature controlled trim suspension (a temperature range from 90 to 180 degrees Fahrenheit, but optimally approximately 105 degrees Fahrenheit) is injected into the colder raw meat muscle mass (a temperature range from 32 to 48 degrees Fahrenheit).

### DETAILED DESCRIPTION OF THE INVENTION

This process may be used on all meat, including beef, pork, poultry, veal, and lamb. The meat muscle to be treated by the process of the present invention is first prepared in the industry's standard manner, that is, it is deboned and has the trim removed. If trim is unavailable from the meat to be treated, trim from a like meat or meat from other meat cuts may be used. Trim for purposes of the present invention includes fat and some lean muscle tissue. Trim values can range from 5% lean and 95% fat to 96% lean and 4% fat. Trim of different values can be mixed to achieve targeted composite value. The optimum composite value for the present invention is from 10% lean and 90% fat to 30% lean and 70% fat. The trim should be stored at temperatures of 40 degrees Fahrenheit or less to maintain freshness until ready to use.

The cold trim is next ground in the industry's standard manner, that is, it is chilled or even frozen to facilitate grinding by a grinding apparatus to a particle size of between approximately 1/16 of an inch and ½ of an inch depending upon the trim value used and the mill equipment to be used in the next step. The trim temperature should be monitored and maintained below 40 degrees Fahrenheit during and after this process. The ground trim can be processed in a number of different industry standard ways to pasteurize the ground trim if desired.

The ground trim is then heated in one of the industry's standard manners, for example a steam jacketed kettle, to a temperature where the fat is liquefied, at least to a temperature high enough for the solution to be pumped, milled, and the suspension injected into the meat muscle. This step differentiates this invention from prior cold suspension art because the warm fluid fat, rather than brine or other additives, provides the injectable suspension. This step differentiates this invention from prior hot fat art because lean meat particles are suspended in the all-meat solution that is then injected into the meat muscle. The USDA distinguishes the injection of trim from the injection of fat in its regulations. This forms viable consumer and viable economic advantages for the use of trim rather than fat.

The warm fluid solution is next passed through a mill in the industry's standard manner, that is, it is pumped or sucked through a mill, depending upon the type of equipment chosen, from a holding tank through the mill to another holding tank to reduce the lean particles to a size that will pass through the injector needle holes without clogging. The milling process is repeated until the desired particle size is achieved. This size typically ranges from 4/10 millimeter to 1.5 millimeter depending on the injector equipment used and the desired finished appearance. The milling process also creates a suspension of the lean particles in the fluid fat. From this point on the suspension is stirred to maintain the suspension until injected.

The warm trim suspension is next injected through one of the industry's standard injectors into the colder meat muscle. The type of injector used, the pressure used to inject the suspension and the number of needles, number of holes per needle and the needle hole size can be combined in numerous ways with this present invention to achieve a desired set of results for key variables, three of which are pounds of meat muscle injected per hour, pounds of suspension injected per hour, and appearance of finished product desired. The temperature of the warm suspension can range from 90 degrees Fahrenheit to over 180 degrees Fahrenheit. An optimal level is approximately 105 degrees Fahrenheit. At this temperature the suspension is fluid enough to be pump by standard injectors yet cool enough so that the lean meat particle proteins are not denatured and that the whole meat muscle proteins surrounding the injected suspension is not denatured. The result is normal looking raw meat cuts with normal looking marbled flecks of fat. At temperatures above approximately 105 degrees Fahrenheit, the raw meat protein becomes denatured (turning brown) and the appearance of the raw meat cuts look abnormal. If part of the process is cooking the meat after injection or if abnormal appearance is acceptable for the application, then temperatures above 105 degrees Fahrenheit can be used. The meat muscle mass to be injected should have a temperature range from 32 degrees Fahrenheit to 48 degrees Fahrenheit. The temperature in the 35 to 40 degree Fahrenheit range will improve the appearance of the meat cuts and improve the final product shelf life.

The above-described process results in a 3% to 20% increase in green weight of the meat by adding a warm particle suspension of trim. At the same time, the added fat marbling adds improved flavor and juiciness to the cooked meat, improving consumer satisfaction with the meat cut. This present invention provides an even distribution of marbling within each cut that provides consistent eating quality, unlike current methods to achieve marbled meat cuts. At injection levels between 10% and 15%, the meat cut has flavor and juiciness characteristics similar to USDA graded prime beef in middle meats as well as end meats. This consistent product eating performance improvement comes at a lower cost because the industry can utilized trimmed external fat to increase the internal marble fat for a functional improvement.

Various aspects of the process of the present invention have been particularly describes in the specification herein, however it must be understood that these particular aspects merely illustrate and that the invention is to be given its fullest interpretation within the terms of the appended claims.

What is claimed is:

1. A process for injecting suspended trim, without the need for a brine, into a meat muscle mass, the steps of the process are as follows: a) removing trim from meat, said trim consisting of fat and lean meat; b) reducing the temperature of said trim to less than 40 degrees Fahrenheit; c) grinding said trim in a grinding apparatus; d) heating the trim to liquefy the fat, an optimum temperature of approximately 105 degrees Fahrenheit will allow the suspension to be injected while not denaturing the protein in the lean meat; e) milling the warm trim in a milling apparatus to reduce the particle size so that the particles pass through the injector needle holes without clogging and a suspension solution is achieved; f) injecting the relatively warmer temperature trim suspension into said relatively colder temperature meat muscle, said meat muscle having a temperature of between 32 degrees Fahrenheit and 48 degrees Fahrenheit, whereby said injection process increases the weight of said meat and improves the meat flavor by the addition of intramuscular fat (marbling). By injecting warm suspension, at approximately 105 degrees Fahrenheit, into the colder meat muscle, the meat muscle surrounding the warm suspension will not denature (and turn color).

2. A process as in claim 1 including the step of adding a brine solution to the suspension prior to the injecting step (1.f).

3. A process as in claim 1 including the step of adding a pickle solution to the suspension prior to the injecting step (1.f).

4. A process as in claim 1 including the step of adding flavor enhancing ingredients to the suspension prior to the injecting step (1.f).

5. A process as in claim 1 but the trim suspension can be injected at temperatures higher than approximately 105 degrees Fahrenheit if the finished meat product is going to be sold cooked.
